(19) United States
(12) Patent Application Publication
(10) Pub. No.: US 2004/0239809 A1
(43) Pub. Date: Dec. 2, 2004

(54) Method and apparatus to display multi-picture-in-guide information

(76) Inventors: Do-young Kim, Suwon-si (KR); Min-hyung Jang, Seoul (KR)

Correspondence Address: STANZIONE & KIM, LLP, 1740 N STREET, N.W., FIRST FLOOR, WASHINGTON, DC, 20036, US

(21) Appl. No.: 10/807,266

(22) Filed: Mar. 24, 2004

(30) Foreign Application Priority Data
May 26, 2003 (KR) 2003-33344

(51) Int. Cl. H04N 5/445; G06F 3/00; G06F 13/00; H04N 5/45

(52) U.S. Cl. 348/563; 725/43; 725/41; 348/564; 348/565; 725/44

(57) ABSTRACT

A method and an apparatus to display multi picture-in-guide information. The method includes displaying electronic program guide (EPG) background screen having a main PIG screen and a plurality of sub PIG screens if an EPG mode for a current channel is requested; detecting EPG information on the current channel to display in texts on the EPG background screen, displaying tuned moving pictures of the current channel on the main PIG screen, while sequentially detecting EPG information for other channels, capturing pictures from the other channels, and displaying the detected EPG information in texts on the EPG background screen and displaying the captured pictures as still pictures on the sub PIG screens; and whenever a channel is selected among the displayed EPG information, tuning the channel as the current channel and updating the main PIG screen and the sub PIG screens.

### CROSS-REFERENCE TO RELATED APPLICATIONS

This application claims the priority of Korean Patent Application No. 2003-33344, filed May 26, 2003, in the Korean Intellectual Property Office, the disclosure of which is incorporated herein in its entirety by reference.

### QBACKGROUND OF THE INVENTION

1. Field of the Invention

The present invention relates to a digital television receiver system, and more particularly, to a method and apparatus to display multi-picture-in-guide information using electronic program guide information in a digital television or a digital set-top box.

2. Description of the Related Art

Generally, a digital television or a digital set-top box adopting an advanced television system committee (ATSC) scheme selectively receives broadcast signals according to a user's channel selection to output video and audio signals. The digital television or the set-top box displays broadcast information using an electronic program guide.

An electronic program guide (EPG) is a kind of broadcast data, which functions to guide broadcast programs to allow a user to conveniently select a channel.

The digital television or the digital set-top box decodes and converts EPG information into an on screen display (OSD) and displays the converted EPG information, such as the OSD, of the broadcast programs on a screen.

FIG. 1 is a view showing a screen with a conventional displaying structure of EPG information in a digital television. As shown in FIG. 1, the EPG information is provided in a 2 dimensional arrangement having information of channels and contents in texts and some graphics. When a user requires an EPG mode, the digital television displays broadcast signals of a current channel in a background or in the form of a picture-in-guide while providing text information of the current channel and other channels. The digital television represents the information of other channels only in texts, so that the user can focus on a picture of the current channel.

### SUMMARY OF THE INVENTION

In order to solve the foregoing and/or problems, it is an aspect of the present invention to provide a method and apparatus to display multi picture-in-guide information, which provides visualized information of broadcast programs by representing a current channel in a moving picture and text information and other channels in a still picture and text information.

Additional aspects and/or advantages of the invention will be set forth in part in the description which follows and, in part, will be obvious from the description, or may be learned by practice of the invention.

In order to achieve the foregoing and/or other aspects of the present invention, there is provided a method of displaying multi picture-in-guide (PIG) information, the method comprising: displaying an electronic program guide (EPG) background screen having a main PIG screen and a plurality of sub PIG screens if an EPG mode for a current channel is requested; detecting EPG information on the current channel to display in texts on the EPG background screen, displaying tuned moving pictures of the current channel on the main PIG screen, while sequentially detecting EPG information for other channels, capturing pictures from the other channels, and displaying the detected EPG information in texts on the EPG background screen and displaying the captured pictures as still pictures on the sub PIG screens; and whenever a channel is selected among the displayed EPG information as the current channel, tuning the channel and updating the main PIG screen and the sub PIG screens.

According to an aspect of the present invention, the operation of tuning the channel comprises tuning the other channels, which are not selected as the current channel, to sequentially update the sub PIG screens.

According to another aspect of the present invention, the operation of tuning the channel comprises tuning a channel indicated by a cursor as the current channel to display moving pictures of the channel on the main PIG screen.

According to yet another aspect of the present invention, the operation of detecting the EPG information on the current channel comprises: detecting the EPG information for the current channel, displaying the EPG information for the current channel on the EPG background screen, and displaying video signals of the current channel on the main PIG screen presented in the EPG background screen. The operation of detecting the EPG information on the current channel further comprises tuning the other channels sequentially from a channel map in which a plurality of the other channels are stored, detecting EPG information of the tuned other channels, capturing pictures of the tuned other channels, displaying the detected EPG information in texts on the EPG background screen, and displaying the captured pictures in the still pictures on the sub PIG screen.

In order to achieve the foregoing and/or other aspects of the present invention, there is also provided a digital broadcast receiving system which receives transport streams with electronic program guide (EPG) information, the digital broadcast receiving system comprising: a multi tuner, which tunes each broadcast signal of channels in the form of the transport streams; a de-multiplexer, which de-multiplexes the tuned broadcast signal into a video stream, an audio stream, and the EPG information; an image processor, which performs image processing on the de-multiplexed broadcast signal from the de-multiplexer; a picture-in-guide (PIG) processor, which constructs a multi PIG screen having a main PIG screen and a plurality of sub PIG screens, and a program information screen in the form of a table, using the EPG information; a display unit, which displays video signals output from the image processor and the PIG processor; and a controller, which controls video signals of a selected channel to be displayed on the main PIG screen in an EPG mode, controls still pictures of other channels to be displayed on the sub PIG screens, and updates information on the main PIG screen by a channel selection from the EPG information displayed in the display unit.

According to an aspect of the present invention, the digital broadcast receiving system further comprises a key input unit which allows a user to select the EPG mode and to select a desired channel from the displayed EPG information.

According to another aspect of the present invention, the digital broadcast receiving system further comprises a memory which stores the EPG information and the still pictures from the controller.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a view showing a screen with a conventional displaying structure of EPG information in a digital television;

FIG. 2 is a block diagram showing a digital broadcast receiver employing a method of displaying multi picture-in-guide information according to an embodiment of the present invention;

FIG. 3 is an electronic program guide screen displayed by a picture-in-guide processing unit of a digital broadcast receiver according to another embodiment of the present invention; and

FIG. 4A and 4B are flowcharts showing a method of displaying multi picture-in-guide information according to another embodiment of the present invention.

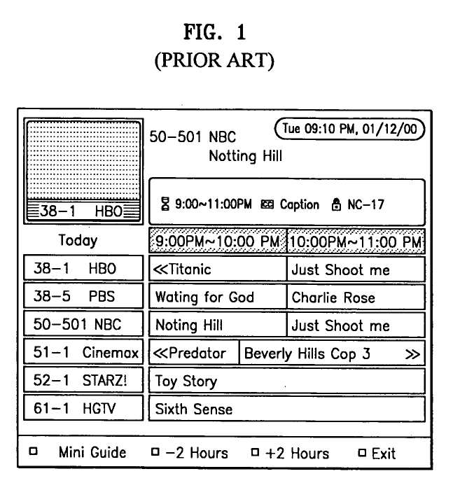

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

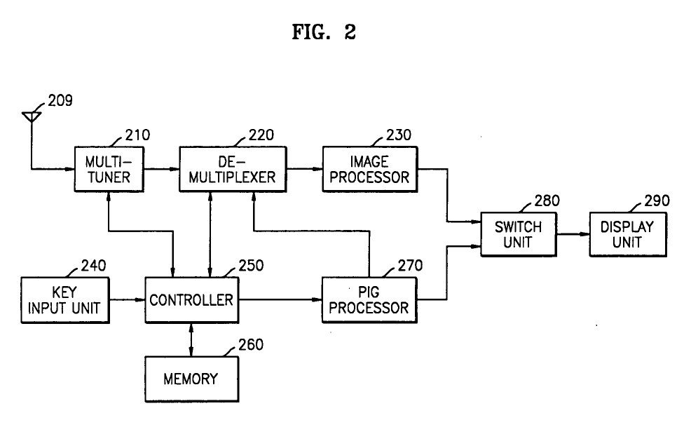

FIG. 2 is a block diagram showing a digital broadcast receiver employing a method of displaying multi-picture-in-guide information according to an embodiment of the present invention.

Referring to FIG. 2, a multi-tuner 210 includes one or more tuners to simultaneously or sequentially tune each broadcast signal as a transport stream received by an antenna 209 based on tuning control data generated from a controller 250. The transport stream can be divided into a header part and a payload part. The header part includes information indicating the beginning of signals and a packet identifier (PID) of a signal in the payload part. The payload part includes video and audio information and electronic program guide (EPG) information of each channel. The EPG information has a master guide table (MGT), a virtual channel table (VCT), a rating region table (RRT), an event information table (EIT) and a system time table (STT) based on the program and system information protocol (PSIP).

In FIG. 2, a de-multiplexer 220 refers to the PID and de-multiplexes the time multiplexed transport stream into a video stream, an audio stream, and EPG information.

An image processor 230 decodes the de-multiplexed video stream from the de-multiplexer 220 into an original image signal.

A picture-in-guide (PIG) processor 270 constructs a multi-picture-in-guide (PIG) screen and a program guide (information) screen in the form of a table in advance and generates an on-screen display (OSD) form of the information of the program guide such as the EPG picked out of the controller 250. The PIG processor 270 may include a single integrated chip having a vertical blanking interval (VBI) decoder/slicer, an OSD generator, a digital to analog converter (DAC), a synchronizer circuit and a memory, and another integrated chip having a multi picture-in-picture(PIP) generator, a DAC, a synchronizer circuit and a microprocessor interface circuit. The multi PIP generator uses a plurality of video signals to create a main screen and several sub screens. The sub screens are generated by decimating a subordinate video signal, for example, by writing into a video memory a single pixel out of three pixels disposed on a selected line out of three lines.

A switch unit 280 switches to an output from the image processor 230 or to an output from the PIG processor 270, selectively.

A display unit 290 displays the image signal output from the switch unit 280 on the screen.

The controller 250 controls an operation of each part of the digital broadcast receiver, stores the EPG information out of the de-multiplexer 220 into a memory 260, reads the EPG information stored in the memory 260 according to a request for an EPG mode by a user, and sends the EPG information to the PIG processor 270. To be more specific, when the controller 250 receives a command of the request for the EPG mode, the controller 250 controls tuning of a current channel, on which the EPG mode is executed by the user, and other channels, respectively, and outputs the resulting tuned information to the PIG processor 270. Especially, the controller 250 assigns a main PIG screen for a moving picture of the current channel and sub PIG screens for sequentially captured still pictures of the other channels. At this time, the controller 250 inputs the video signals de-multiplexed from the de-multiplexer 220 channel by channel to the main PIG screen and the sub PIG screens generated from the PIG processor 270, respectively.

The memory 260 stores the EPG information of each channel as well as the still pictures of the channels.

A key input unit 240 allows the user to enter various commands each of which causes a related operation corresponding to a request for the EPG mode, and transfers the commands to the controller 250. Especially, the key input unit 240 has keys corresponding to channel up, channel down, and channel numbers and selects a desired channel from the displayed EPG information.

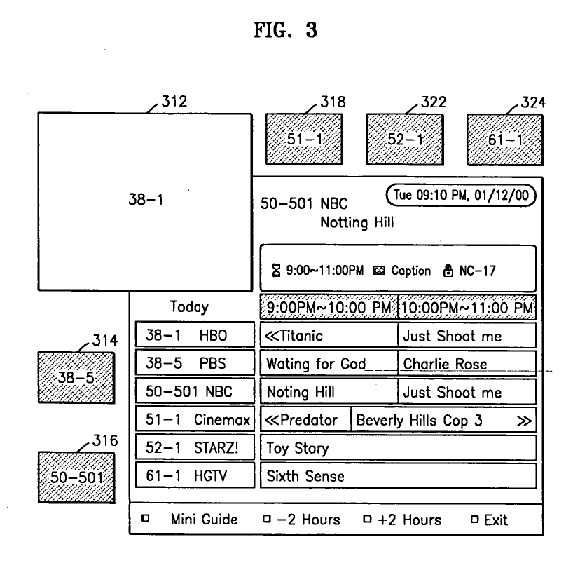

FIG. 3 is an electronic program guide (EPG) screen having the multi PIG screen disposed by the picture-in-guide processing unit 270 of FIG. 2.

Referring to FIG. 3, in the EPG mode, the EPG information of all the channels is displayed in texts within the form of a table. A channel denoted as 38-1 in FIG. 3, which is currently watched by a user is tuned in and displayed in a moving picture on a main PIG screen 312. Other channels denoted as 38-5, 50-501, 51-1, 52-1, and 61-1, are tuned sequentially and displayed in corresponding sub PIG screens 314, 316, 318, 322, and 324, respectively.

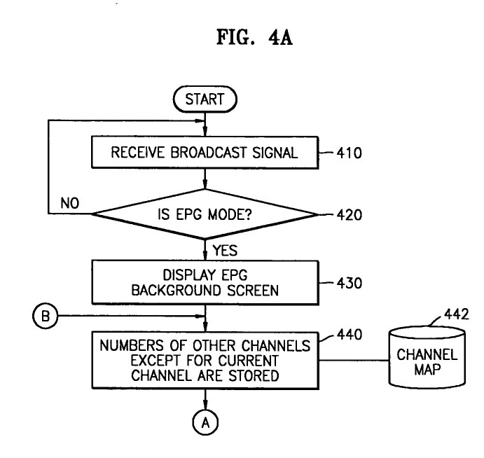

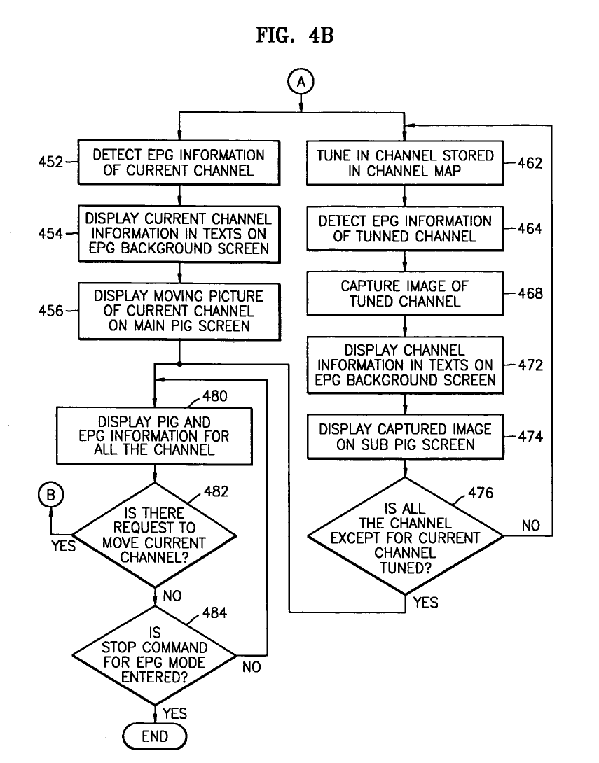

FIGS. 4A and 4B are flowcharts showing a method of displaying multi-picture-in-guide information in a digital broadcast receiver according to another embodiment of the present invention.

Referring to FIGS. 2 through 4B, broadcast signals in the form of transport streams are received from a single or a plurality of tuners 210 in the digital broadcast receiver in operation 410.

It is checked whether there has been a request for an EPG mode via the key input unit 240 by a user in operation 420.

In operation 420, if it is determined that there has been the request for the EPG mode, an EPG background screen is displayed in operation 430. The EPG background screen includes a main screen and a plurality of sub screens.

Then, other channel numbers 38-5, 50-501, 51-1, 52-1, 61-1, except for the current watching channel number 38-1 in FIG. 3, are arrayed and stored in a channel map 442 in operation 440.

Displaying a multi PIG for the current watching channel and other channels and EPG information is performed with multi processing.

To display the multi PIG for the current channel and other channels, firstly, broadcast signals of the current channel 38-1 are tuned using a first tuner. Then, the EPG information from the tuned broadcast signals is detected in operation 452. The detected EPG information of the current channel is displayed in texts on the EPG background screen in operation 454. Video signals of the current channel are displayed on the main PIG screen 312 in FIG. 3 in operation 456.

To display the multi PIG for the other channels, broadcast signals of a channel stored in the channel map 442 are first tuned in using a second tuner in operation 462. EPG information from the tuned broadcast signals is detected in operation 464. An image signal from the tuned channel is captured in operation 468. Corresponding channel information is displayed in texts on the EPG background screen in operation 472, while the captured image is displayed as a still picture on a sub PIG screen in operation 474. In operation 476, it is checked whether the operations 462 through 474 are performed for all the channels stored in the channel map 442, and if not so, the operations are repeated.

After the multi PIG for the current channel and the other channels are displayed, the PIG and EPG information of the current channel and the other channels are displayed on the EPG background screen in operation 480. In other words, the moving picture and the text information are provided for the current channel, and the still picture and the text information are provided for the other channels.

Then, in operation 482, it is checked, for example, in the EPG background screen shown in FIG. 3, whether the EPG information of another channel is being scrolled. Scrolling is recognized from a cursor positioned on the EPG background screen.

If the cursor is recognized to be in another channel display area, for example, in the display area of channel 38-5 in FIG. 3, the channel is considered as the current channel and the previous channel, e.g., 38-1 as shown in FIG. 3, is updated as a channel for use of a sub PIG screen. At this time, the moving picture of the channel, on which the cursor is located, and, which becomes the current watching channel, is displayed on the main PIG screen 312, and still pictures of the other channels on which the cursor is not located, e.g., 31-1, 50-501, 51-1, 52-1, and 61-1 are displayed in sub PIG screens 314, 316, 318, 312, and 314, respectively. Consequently, video signals for a channel on which the cursor is located, among channels as shown in FIG. 3, are displayed on the main PIG screen 312.

It is checked whether a stop command is input from the key input unit 340 in operation 484. If not so, operations 480 to 482 are repeated.

It is possible that the method and apparatus described above are implemented as computer readable codes on recording media accessible by a computer. The recording media include all kinds of recording devices, such as ROM, RAM, CD-ROM, a magnetic tape, hard discs, floppy discs, a flash memory, an optical data storage device, etc., in which computer-readable data can be stored. The recording media may also include signals transmitted by carrier waves, e.g., internet transmission. In addition, the media can be in the form of codes distributed to a plurality of computer systems connected to a network, and may be stored and executed using a distribution method.

As described above, the method and apparatus to display multi-picture-in-guide information provides a moving picture and texts information for a current channel, and still pictures and texts information for other channels, thereby allowing a user to view visualized broadcast information.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of displaying EPG information, the method comprising:
displaying an electronic program guide (EPG) background screen having a main PIG screen and a plurality of sub PIG screens to display multi-picture-in-guide (PIG) information if an EPG mode for a current channel is requested;
detecting the EPG information on the current channel to display in texts on the EPG background screen, displaying tuned moving pictures of the current channel on the main PIG screen while sequentially detecting the EPG information for other channels, capturing pictures from the other channels, and displaying the detected EPG information in texts on the EPG background screen and displaying the captured pictures as still pictures on the sub PIG screens; and
whenever a channel is selected among the displayed EPG information as current channel, tuning the channel and updating the main PIG screen and the sub PIG screens.

2. The method of claim 1, wherein the operation of tuning the channel and updating the main and sub PIG screen channels comprises tuning other channels not selected sequentially to update the sub PIG screens.

3. The method of claim 1, wherein the operation of tuning the channel and updating the main and sub PIG screen channels comprises tuning a channel indicated by a cursor to display moving pictures of the channel on the main PIG screen.

4. The method of claim 1, wherein the operation of detecting EPG information on the current channel comprises:
detecting the EPG information for the current channel, displaying the EPG information for the current channel on the EPG background screen, and displaying video signals of the current channel on the main PIG screen presented in the EPG background screen;
tuning other channels sequentially from a channel map in which a plurality of the other channels is stored, detecting EPG information of the tuned other channels, capturing pictures of the tuned other channels, displaying the detected EPG information in texts on the EPG background screen, and displaying the captured pictures in still pictures on the sub PIG screen.

5. A digital broadcast receiving system which receives transport streams with electronic program guide (EPG) information, the digital broadcast receiving system comprising:
a multi tuner which tunes each broadcast signal of channels in the form of the transport streams;
a de-multiplexer which de-multiplexes the tuned broadcast signal into a video, an audio and the EPG information;
an image processor which performs image processing on the de-multiplexed broadcast signal from the de-multiplexer;
a picture-in-guide (PIG) processor which constructs a multi PIG screen having a main PIG screen and a plurality of sub PIG screens, and a program information screen in the form of a table, using the EPG information;
a display unit which displays video signals output from the image processor and the PIG processor; and
a controller which controls in an EPG mode video signals of a selected channel to be displayed on the main PIG screen, controls still pictures of other channels to be displayed on the sub PIG screens, and updates information on the main PIG screen by a channel selection from the EPG information displayed in the display unit.

6. The system of claim 5, further comprising a key input unit which allows a user to select the EPG mode and a desired channel from the displayed EPG information as the selected channel.

7. The system of claim 5, further comprising a memory which stores the EPG information and the still pictures from the controller.

8. A recording medium encoded with codes readable by a computer to implement a method of generating (EPG) information to be displayed in an EPG background screen in an EPG mode in a display apparatus, the method comprising:
forming a main PIG screen on a multi-PIG screen of the EPG background screen to display a moving picture of a first channel;
forming a sub PIG screen on the multi-PIG screen of the EPG background screen to display a still picture of a second channel; and
forming a sub screen on the multi-PIG screen of the EPG background screen to display channel information of the EPG information in text.

9. The recording medium of clam 8, wherein the method further comprises generating the moving picture of the first channel and the still picture of the second channel to be displayed in the main PIG screen and the sub PIG screen of the multi-PIG screen, respectively.

10. The recording medium of claim 8, wherein the method further comprises generating channel information of the EPG information to be displayed in the sub-screen of the EPG background screen.

11. The recording medium of claim 8, wherein the channel information includes information about the first and second channel and other channels.

12. The recording medium of claim 8, wherein the method further comprises generating a cursor to be displayed on the EPG background screen to allow a user to select one of the second channel and another channel displayed on the sub PIG screen and the sub screen, respectively.

13. The recording medium of claim 8, wherein the method further comprises:
generating the moving picture corresponding to the selected one of the second channel and another channel to be displayed in the main PIG screen; and
generating the still picture corresponding other channel than the second channel to be displayed in the sub PIG screen.

14. A method of generating (EPG) information to be displayed on an EPG background screen in an EPG mode in a display apparatus, the method comprising:
forming a main PIG screen on a multi-PIG screen of the EPG background screen to display a moving picture of a first channel;
forming a sub PIG screen on the multi-PIG screen to display a still picture of a second channel; and
forming a sub screen on the multi-PIG screen to display channel information of the EPG information in text.

15. The method of clam 14, further comprising:
generating the moving picture of the first channel and the still picture of the second channel to be displayed in the main PIG screen and the sub PIG screen of the multi-PIG screen, respectively; and
generating channel information of the EPG information to be displayed in the sub-screen of the EPG background screen.

16. The method of claim 14, further comprising:
generating a cursor to be displayed on the EPG background screen to allow a user to select one of the second channel and another channel displayed on the sub PIG screen and the sub screen, respectively.

17. The method of claim 14, further comprising:
generating the moving picture corresponding to the selected one of the second channel and another channel to be displayed in the main PIG screen;
generating the still picture corresponding other channel than the second channel to be displayed in the sub PIG screen; and generating channel information of the EPG information to be displayed in the sub-screen of the EPG background screen.

18. An apparatus to generate (EPG) information to be displayed on an EPG background screen in an EPG mode in a display apparatus, comprising:
a PIG processor to form a main PIG screen on a multi-PIG screen of the EPG background screen to display a moving picture of a first channel, a sub PIG screen on the multi-PIG screen of the EPG background screen to display a still picture of a second channel, and a sub screen on the multi-PIG screen of the EPG background screen to display channel information of the EPG information in text.

19. The apparatus of clam 18, further comprising:
a demultiplexer to generate the moving picture of the first channel and the still picture of the second channel to be displayed in the main PIG screen and the sub PIG screen of the multi-PIG screen, respectively, and to generate channel information of the EPG information to be displayed in the sub-screen of the EPG background screen.

20. The apparatus of claim 19, further comprising:
a controller to generate a cursor to be displayed on the EPG background screen to allow a user to select one of the second channel and another channel displayed in the sub PIG screen and the sub screen, respectively.

21. The apparatus of claim 20, further comprising:
a controller to control the PIG processor and the demultiplexer to generate the moving picture corresponding to the selected one of the second channel and another channel to be displayed in the main PIG screen, to generate the still picture corresponding other channel than the second channel to be displayed in the sub PIG screen, and to generate channel information of the EPG information to be displayed in the sub-screen of the EPG background screen.
